(19) United States
(12) Patent Application Publication
(10) Pub. No.: US 2022/0180689 A1
(43) Pub. Date: Jun. 9, 2022

(54) INTERGRATED MANAGEMENT SYSTEM FOR FIRST AID KIT VENDING MACHINES AND METHOD THEREOF

(71) Applicants: Dae Wook Kwon, Seoul (KR); IAN ROAD Co., Ltd., Seoul (KR)

(72) Inventor: Dae Wook Kwon, Seoul (KR)

(73) Assignees: IAN ROAD Co., Ltd.; Dae Wook Kwon

(21) Appl. No.: 17/505,938

(22) Filed: Oct. 20, 2021

(30) Foreign Application Priority Data
Nov. 26, 2020 (KR) 10-2020-0160580

(51) Int. Cl. G07F 9/00; G07F 9/02; G07F 17/00

(52) U.S. Cl. CPC G07F 9/002; G07F 17/0042; G07F 9/026

(57) ABSTRACT

The present disclosure relates to an integrated management system for first aid kit vending machines and a method thereof. The integrated management system for first aid kit vending machines of the present disclosure may integrally manage a plurality of first aid kit vending machines by managing position information for each of the plurality of first aid kit vending machines and information on a product for the first aid kit to be sold, and by monitoring the sale, stock and the like of each first aid kit vending machine in real time. According to the present disclosure, it is thus possible to enable fast supply of the product by automatically requesting an order for the product to the product supplier when the product stock in the first aid kit vending machine is less than or equal to the predetermined standard stock or the product is sold out.

### FIELD OF THE INVENTION

This application claims the priority benefit of Korean Patent Application No. 10-2020-0160580 filed on Nov. 26, 2020, the entire contents of which are incorporated herein by reference.

### BACKGROUND OF THE INVENTION

The present disclosure relates to an integrated management system for first aid kit vending machines and a method thereof, and more particularly, to an integrated management system for first aid kit vending machines and a method thereof, in which the system may integrally perform the computerized management, payment management, distribution management and product supply management of the first aid kit vending machines in real time by allowing a manager to monitor the warehousing, sale, stock and the like of each product for a plurality of first aid kit vending machines capable of being identified from each other, being installed in different places, and each selling first aid kits having various purposes automatically and unattended, and by notifying the manager or automatically requesting an order for the product to the product supplier when the product stock is less than or equal to a predetermined stock or the product is sold out.

In general, a vending machine may be installed in any of various places to sell various products automatically and left unattended for a buyer to easily purchase the product anytime and anywhere. The vending machine may allow the buyer to conveniently purchase the product regardless of time and place, and also allow a seller to sell the product without renting a store. The vending machine may thus sell the product at a lower maintenance cost than a store rental, and accordingly, may sell the same product at a lower price. Therefore, the vending machine may give the seller high profitability. This vending machine may be positioned for the product to be automatically discharged when the buyer pays a price of the product that the buyer wants to purchase without the seller's permanent attendance.

However, a manager managing the vending machine may not know a stock volume of the product sold from the vending machine in real time. Therefore, a product sale may be frequently suspended due to shortage of the stock. However, it is difficult for the manager to know this shortage in real time, and also to recognize this state of sales suspension. Accordingly, it is inconvenient that the manager or a product supplier needs to visit a position of the vending machine periodically for a predetermined period of time to monitor and manage a state of the vending machine. In addition, the product sold from the vending machine may continue to be out of stock during a period when the manager or the product supplier fails to check this sold-out, and accordingly, the buyer may not purchase the desired product when needed.

A first aid kit may accommodate over-the-counter drugs that a user may purchase without a prescription, such as a first aid medicine or an emergency kit, and accommodate, for example, a variety of over-the-counter drugs for each use in order for the user to take prompt action in the event of an emergency occurring due to wound, burn, fracture, infectious disease, etc. Such a vending machine that automatically sells these unattended first aid kits, i.e., the first aid kit vending machines, may enable the user to purchase the over-the-counter drugs even after hospital and pharmacy business hours are over. Therefore, the user may purchase the medicine without a prescription and provide prompt first aid in the event of an emergency.

Nevertheless, it is difficult for the buyer to know the installation place of the first aid kit vending machine, and the buyer may thus wander around to find its installation place for a long time. Even though the buyer finds the first aid kit vending machine with difficulty, the buyer may not purchase the product when the desired product is sold out.

Therefore, even in an emergency, it may be impossible for the buyer to secure a first aid kit in his/her vicinity, or it may take a lot of time to secure the first aid kit from the nearest first aid kit vending machine. As a result, the buyer may not take a prompt action in the emergency situation.

### RELATED ART DOCUMENT

(Patent Document 1) Korean Patent Publication No. 10-1631663 (Jun. 24, 2016)
(Patent Document 2) Korean Patent Publication No. 10-1087709 (Nov. 30, 2011)
(Patent Document 3) Korean Patent Laid-Open Publication No. 10-2020-0009455 (Jan. 30, 2020)
(Patent Document 4) Korean Patent Laid-Open Publication No. 10-2017-0092845 (Aug. 14, 2017)

### SUMMARY OF THE INVENTION

An aspect of the present disclosure may provide an integrated management system for first aid kit vending machines and a method thereof, the system integrally managing a plurality of first aid kit vending machines installed in different places online in real time.

Another aspect of the present disclosure may provide an integrated management system for first aid kit vending machines and a method thereof, the system inter-working with a manager terminal and a product supplier system to sell a product by quickly supplying the product to the first aid kit vending machine when a product stock in the vending machine is less than or equal to a predetermined stock or the product is sold out.

Another aspect of the present disclosure may provide an integrated management system for first aid kit vending machines and a method thereof, the system enabling the manager to monitor and manage an overall management process of the first aid kit vending machine online in real time.

Another aspect of the present disclosure may provide an integrated management system for first aid kit vending machines and a method thereof, the system guiding a buyer to the position of the first aid kit vending machine for the buyer to easily purchase the product.

The integrated management system for first aid kit vending machines according to the present disclosure may integrally manage a plurality of first aid kit vending machines capable of being identified from each other and installed in different places in real time by monitoring its operation state and whether the product is in stock. The integrated management system for first aid kit vending machines according to the present disclosure may perform all types of managements for such as the warehousing, sale, stock, statistics and the like of the product for the first aid kit vending machine online, allow the buyer to easily find an installation place of the first aid kit vending machine and prevent a case where the product purchase is not made due to the product being out of stock, thereby having an improved profitability.

According to an aspect of the present disclosure, an integrated management system for first aid kit vending machines includes: a plurality of first aid kit vending machines capable of being identified from each other, being installed in different places, and each automatically selling first aid kit having various purposes; a manager terminal provided with a manager in charge of the first aid kit vending machine; and an integrated management server connected to the first aid kit vending machine through a communication network and receiving identification information from the first aid kit vending machine to identify the first aid kit vending machine, thereby determining position information on its installation place, extracting the first aid kit vending machine corresponding to position information of the manager terminal and providing the position information of the extracted first aid kit vending machine to the manager terminal, and notifying the manager terminal when a product stock in the first aid kit vending machine is less than or equal to a predetermined standard stock or the product is sold out, and requesting an order for the product to the product supplier system when the product stock is less than or equal to the predetermined standard stock or the product is sold out.

According to an aspect, the integrated management server may display the position information of the first aid kit vending machine as an electronic map and a list including an address of its installation place to provide the position information of the first aid kit vending machine and product information of the product sold by the first aid kit vending machine to the manager terminal and a buyer terminal of a buyer who wants to purchase the product from the first aid kit vending machine.

According to an aspect, the integrated management server may further monitor an operation state of the first aid kit vending machine, including at least communication failure, power cut off and malfunction, and may inform the manager terminal of the operation state.

According to an aspect, the integrated management server may predetermine an expiration date of each product in the first aid kit vending machine, and may control the first aid kit vending machine to stop a sale of a specific product when the product has an elapsed expiration date.

According to an aspect, the integrated management server may provide a notification service to the manager terminal when the product stock in the first aid kit vending machine is less than or equal to a first standard stock; and may provide a notification service to the manager terminal and simultaneously request an automatic order for the product to the product supplier system when the product stock in the first aid kit vending machine is less than or equal to a second standard stock lower than the first standard stock.

### BRIEF DESCRIPTION OF THE DRAWINGS

The above and other aspects, features, and advantages of the present disclosure are more clearly understood from the following detailed description taken in conjunction with the accompanying drawings, in which:

FIG. 1 is a block diagram showing a network configuration of an integrated management system for first aid kit vending machines according to the present disclosure;

FIG. 2 is a view showing a configuration of the first aid kit vending machine of FIG. 1;

FIG. 3 is a block diagram showing a partial configuration of the first aid kit vending machine shown in FIG. 2;

FIG. 4 is a block diagram showing a configuration of an integrated management server shown in FIG. 1;

FIG. 5 is a flowchart showing a processing procedure of an automatic request for an order based on a product stock in the first aid kit vending machine according to the integrated management system for first aid kit vending machines of the present disclosure;

FIG. 6 is a flow chart showing a processing procedure of guiding the position and product of the first aid kit vending machine according to the integrated management system for first aid kit vending machines of the present disclosure;

FIG. 7 is a flowchart showing a procedure for determining whether to sell the product based on an expiration date of the product in the first aid kit vending machine according to the integrated management system for first aid kit vending machines of the present disclosure;

FIGS. 8 to 15 are diagrams each showing an application screen of a manager terminal to manage the first aid kit vending machine according to an embodiment of the present disclosure; and

FIG. 16 is a diagram showing an application screen according to another embodiment of the present disclosure.

### DETAILED DESCRIPTION OF THE INVENTION

The embodiments of the present disclosure may be modified in various forms, and the scope of the present disclosure should not be construed as being limited to the embodiments described below. The embodiments are provided to more fully explain the present disclosure to those skilled in the art. The shape and the like of a component in the drawing may thus be exaggerated to emphasize a clearer description.

An integrated management system for first aid kit vending machines according to present disclosure may integrally manage a plurality of first aid kit vending machines capable of being identified from each other, and installed in different places online in real time, by managing position information for each of the plurality of first aid kit vending machines and information on a product for the first aid kit to be sold; by monitoring the product sale, stock and the like of each first aid kit vending machine in real time; by processing supply of the first aid kit by promptly requesting a product supplier to purchase the first aid kit when a stock of the first aid kit is less than or equal to a predetermined stock or the first aid kit is sold out; and by integrally performing the computerized management, payment management, distribution management and product supply management of the first aid kit vending machines in real time.

Here, the first aid kit may accommodate over-the-counter drugs including a simple medicine, a treatment tool and an emergency kit that may be purchased at a pharmacy and a convenience store without a separate prescription, i.e. a variety of daily life products, for example, a disinfectant, a wound ointment, a band-aid, a paste, a mask, a hand sanitizer, sterile scissors, a sanitary pad, etc.

Therefore, the integrated management system for first aid kit vending machines of the present disclosure may integrally manage the first aid kit vending machines by connecting the plurality of first aid kit vending machines and an integrated management server through a communication network, and allowing the integrated management server to inter-work with a manager terminal and a product supplier system.

According to the present disclosure, it is possible to integrally manage the first aid kit vending machines managed by a manager online in real time, and a buyer may easily find the first aid kit vending machine and purchase the first aid kit when needed.

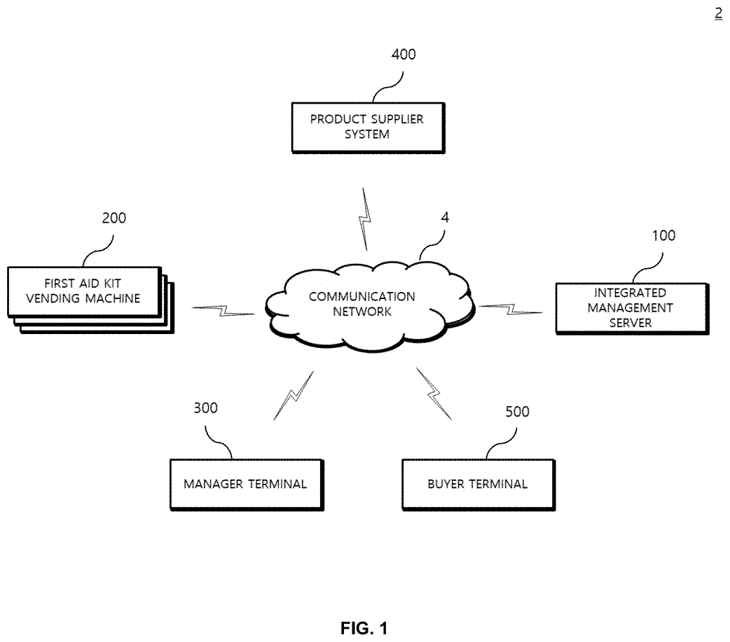

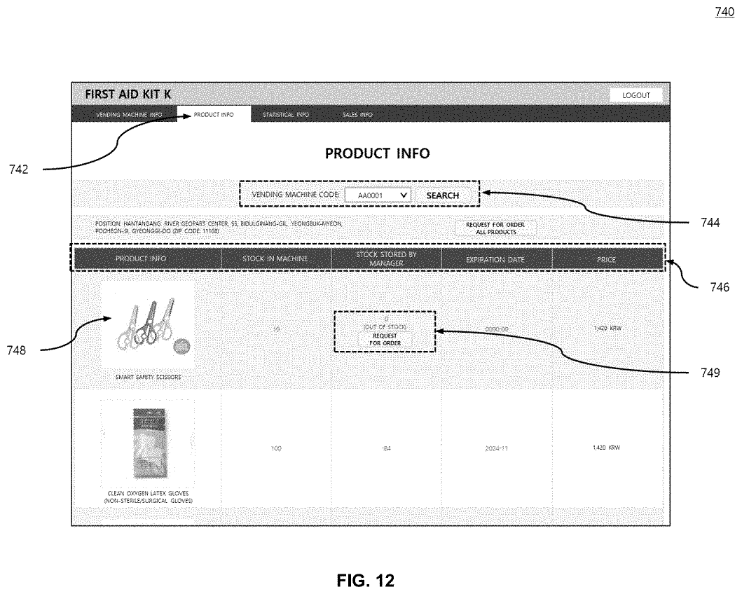

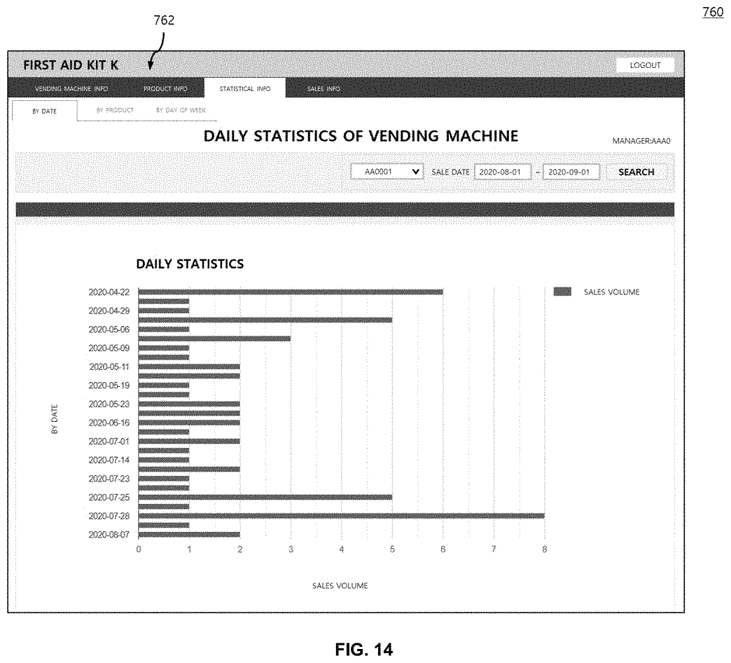

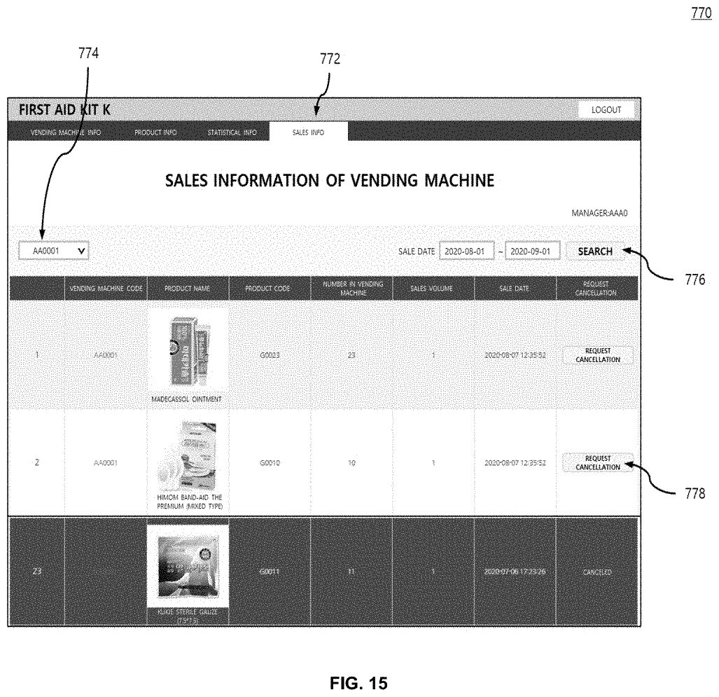

Hereinafter, an embodiment of the present disclosure is described in detail with reference to the accompanying drawings, FIGS. 1 through 16.

FIG. 1 is a block diagram showing a network configuration of an integrated management system for first aid kit vending machines according to the present disclosure.

Referring to FIG. 1, an integrated management system 2 for first aid kit vending machines of the present disclosure may manage a plurality of first aid kit vending machines 200 capable of being identified from each other, being installed in different places, and each automatically selling first aid kits (hereinafter, products) having various purposes online in real time by monitoring the warehousing, sale, stock and the like of the product in the first aid kit vending machine 200 in real time, thereby notifying a manager of the first aid kit vending machine 200 to take a prompt action when a product stock is less than or equal to a predetermined stock or the product is sold out, or also simultaneously making a prompt request for supply of the product to allow the product to be sold by automatically requesting an order for the product to a product supplier who supplies the product to the vending machine when the product stock is less than or equal to another predetermined stock or the product is sold out.

The integrated management system 2 for first aid kit vending machines of the present disclosure may monitor a state of the first aid kit vending machine 200 in real time, and allow the manager to take a prompt action when the product stock is less than or equal to the predetermined stock or the product is sold out, thereby providing a buyer with convenience of purchase and allowing the product to be sold more effectively.

To this end, the integrated management system 2 for first aid kit vending machines of the present disclosure includes the plurality of first aid kit vending machines 200, a manager terminal 300, a product supplier system 400 and an integrated management server 100. In addition, the integrated management system 2 for first aid kit vending machines of the present disclosure may further include a buyer terminal 500. Each of the first aid kit vending machine 200, manager terminal 300, product supplier system 400 and buyer terminal 500 may be connected to the integrated management server 100 through a communication network 4.

In detail, the communication network 4 may be, for example, a wireless communication network, a mobile communication network or the like, and may connect the first aid kit vending machine 200 and the integrated management server 100 to each other, the manager terminal 300 and the integrated management server 100 to each other, the product supplier system 400 and the integrated management server 100 to each other, and the buyer terminal 500 and the integrated management server 100 to each other to enable data communication therebetween.

The first aid kit vending machine 200 may be placed to automatically sell the products having various purposes. The first aid kit vending machines 200 may have identification information such as a vending machine code, thus be identified by the integrated management server 100, and thus be installed in different places for a position of its installation place to be identified from each other. That is, for the buyer to quickly purchase the product when needed regardless of time and place, the first aid kit vending machine 200 may be installed in a variety of places easy to access such as public places and facilities including a building, a site, an outdoor area and the like where many people gather or visit, for example, an apartment complex, a school, a convenience store, a church, a park, a government office, a road rest area, an amusement park, etc.

The first aid kit vending machine 200 may provide, for example, a product set for each use such as wound, burn, fracture, and infection prevention, and an individual product such as a hand sanitizer, a mask, sterile gloves, sterile scissors, a wound ointment, a burn ointment, a band-aid, a disinfectant, an elastic protector, an aerosol, a sterile gauze, etc.

The first aid kit vending machine 200 may be connected to the integrated management server 100 through the communication network 4 to enable the data communication therebetween. The first aid kit vending machine 200 may transmit its identification information to the integrated management server 100 for the integrated management server 100 to determine its installation place.

The first aid kit vending machine 200 may transmit information on warehousing, sale and stock of the product including its type, volume and the like to the integrated management server 100 in real time. For example, the first aid kit vending machine 200 may determine the information on each product stock by calculating the volume of the product based on its warehousing and sale, and transmit the determined information on each product stock to the integrated management server 100 in real time. In addition, the manager may also check the information on the product stock based on the warehousing and sale of each product in each first aid kit vending machine 200, and transmit the checked product stock information to the integrated management server 100 through the manager terminal 300. Here, this stock information may include the volume of the product displayed in the first aid kit vending machine 200 and that of product separately stored by the manager.

The first aid kit vending machine 200 may have a configuration of a typical vending machine that sells various conventional products, for example, a configuration for accepting a product, a configuration for selecting the product, a configuration for paying for the product, a configuration for discharging the product, etc. A description of their functions and actions is omitted here.

The manager terminal 300 may be, for example, a smartphone, a personal computer, a portable computer or the like, and provided with the manager (or operator) in charge of at least one first aid kit vending machine 200. The manager terminal 300 may be connected to the integrated management server 100 through the communication network 4.

The manager terminal 300 may register the manager's personal information, i.e. manager information, in the integrated management server 100, and register vending machine information of the first aid kit vending machine 200 managed by the manager himself/herself by matching with the manager information. That is, the manager terminal 300 may join as a member of the integrated management server 100, and register the plurality of first aid kit vending machines 200 managed by the manager himself/herself in the integrated management server 100 by matching identification information of the first aid kit vending machine 200 to the manager's member identification (ID).

Here, the manager information may include the manager's name, contact information, e-mail address, member ID, password, information on the vending machine managed by the manager himself/herself, etc. This vending machine information may include position information corresponding to the installation place of the vending machine, such as the vending machine code, address and the like, product information of the product being sold, and the information on the product sale such as the same-day sales volume and cumulative sales volume of the product. The vending machine code may be linked with the product information of the product being sold. The position information may include an address, global positioning system (GPS) information and the like of the installation place, and the installation place of the vending machine may thus be displayed by matching this information on an electronic map. The product information may include the vending machine code, a serial number of the product in the vending machine, a product code, a product image, a product name, the product stock in the vending machine, the product stock stored by the manager, a standard stock, an expiration date, a product price, a product supplier, a user manual, a registration date, product sale or sales suspension, product editable or not, etc. The sales information may include the product code, a sale price, sales volume, etc.

The manager terminal 300 may use a first aid kit vending machine application for managing the first aid kit vending machine 200 to search for, select and check the position information of the of the first aid kit vending machine 200 in charge from the integrated management server 100, and thus monitor each of the first aid kit vending machines 200 and each product information. The manager terminal 300 may receive and monitor the information on the warehousing, sale, stock and the like of the product in the first aid kit vending machine 200 in charge from the integrated management server 100. The manager terminal 300 may select information on one product by using the first aid kit vending machine application to check detailed information on the product and add, modify, delete and edit the vending machine information and product information of each first aid kit vending machine 200.

The manager terminal 300 may receive a notification service from the integrated management server 100 in the form of e-mail, text message and a pop-up screen when the product stock in the first aid kit vending machine 200 managed by the manager is less than or equal to the predetermined standard stock or the product is sold out. In addition, the manager terminal 300 may also request an order for the product to the integrated management server 100 for a product newly required or the product in shortage.

The manager terminal 300 may also check the sales information statistically processed based on the product sale from the integrated management server 100, by classifying and extracting the information by first aid kit vending machine, by date, by period, by day of the week, by product, etc.

In addition, the manager terminal 300 may check the sales information and request the integrated management server 100 to cancel payment of the sold product due to, for example, a product return or a defective product, when necessary.

Therefore, the manager may check the operation (or not) and sales information of the first aid kit vending machine 200 by checking the position of at least one first aid kit vending machine 200 corresponding to his/her current position from the integrated management server 100, checking the information on sale and stock of the product in each first aid kit vending machine 200, and warehousing the product supplied from the product supplier to the first aid kit vending machine 200 based on an appropriate stock volume of the product.

The product supplier system 400 may refer to a device installed in each of the plurality of product suppliers supplying the product to the first aid kit vending machine 200, and, for example, may have the form of a server, as well as a communication terminal such as a smartphone or a personal computer. The product supplier system 400 may match with the product information, and may receive the notification service based on the information of each product stock in the first aid kit vending machines 200 from the integrated management server 100, or receive the request for an order for the plurality of products when the product stock is less than or equal to the predetermined standard stock or the product is sold out. In an embodiment of the present disclosure, the product supplier system 400 may receive the notification service when the stock of one product is less than or equal to a first standard stock, i.e. in a range of, for example, about 50 to 60% of the appropriate product stock, and receive the request for an order for the product when the product stock is less than or equal to a second standard stock lower than first standard stock, i.e. in a range of, for example, about 30 to 40% of the appropriate product stock. Here, the product supplier system 400 may receive the product name, product volume, delivery address and personal information of the manager in charge by e-mail, text message, etc. Information on the standard stock volume may be predetermined and stored by the integrated management server 100, and a different standard stock volume may be predetermined for each of the first aid kit vending machines 200 based on the installation place of the first aid kit vending machine 200, the sales volume of the product, etc. For example, when the first aid kit vending machine 200 is installed in a place where many people visit and has a specific product having a lot of sales, or the like, it is possible to promptly supply the product in the event of shortage of the stock by pre-determining its standard stock volume to have a larger range.

When receiving the request for an order from the integrated management server 100, the product supplier system 400 may process the corresponding product to be sent to the manager in response. When the product is sent, the product supplier system 400 may notify the manager terminal 300 and the integrated management server 100 that the product is sent, and may confirm arrival of the product from the manager terminal 300. In addition, when the arrival of the product is confirmed from the manager terminal 300, the product supplier system 400 may notify the integrated management server 100 that the manager already receives the product.

The buyer terminal 500 may refer to a device provided with the buyer who wants to purchase the product from the first aid kit vending machine 200, and may be, for example, a smartphone, a personal computer or the like. The buyer terminal 500 may transmit information on its current position to the integrated management server 100 by using the first aid kit vending machine application. The buyer terminal 500 may receive, from the integrated management server 100, the position information of at least one first aid kit vending machine 200 corresponding to the position information of itself, and the information on the product sold by each of the first aid kit vending machines 200. Accordingly, the buyer terminal 500 may check the position of the first aid kit vending machine 200 and the product being sold, and the buyer may thus purchase the product from the first aid kit vending machine 200 positioned closest to where the product that the buyer needs is positioned.

In addition, the integrated management server 100 may monitor the operation (or not) and sales information of the first aid kit vending machine 200 in real time. The integrated management server 100 may monitor, for example, an operation state of the first aid kit vending machine 200, such as power supply state, communication state, malfunction or the like, or may receive information on the operating state of the first aid kit vending machine 200 from the manager terminal 300.

The integrated management server 100 may perform the computerized management of the first aid kit vending machines 200 by registering and managing the vending machine information, manager information and product supplier information matching with the plurality of first aid kit vending machines 200, manager terminals 300 and product supplier systems 400, respectively. The integrated management server 100 may register and manage the product information of the product sold by each of the first aid kit vending machines 200. The integrated management server 100 may add, modify, delete and edit the vending machine information, the manager information, the product supplier information, the product information, etc. The integrated management server 100 may transmit, to the first aid kit vending machine 200, the product information, and the user manual corresponding to the product information, and product advertisement information, etc.

The integrated management server 100 may receive the identification information from each of the first aid kit vending machines 200 and determine the position, i.e. installation place of each of the first aid kit vending machines 200. When receiving the position information from each of the manager terminal 300 and the buyer terminal 500, the integrated management server 100 may extract at least one first aid kit vending machine 200 corresponding to the position information to each of the manager terminal 300 and the buyer terminal 500, and transmit the installation place of the extracted first aid kit vending machine 200 and the information on the product being sold to each of the manager terminal 300 and the buyer terminal 500. Here, the integrated management server 100 may provide each of the manager terminal 300 and the buyer terminal 500 with the installation place of the first aid kit vending machine 200 displayed as the electronic map or a list including the address.

The integrated management server 100 may receive the information on the warehousing, sale and stock of each product from the first aid kit vending machine 200 or the manager terminal 300 through the communication network 4 in real time. The integrated management server 100 may provide the notification service to the manager terminal 300 when the product stock in the first aid kit vending machine 200 is less than or equal to the standard stock, or may request an order for the product in shortage to the product supplier system 400. Here, the integrated management server 100 may compare information on the stock of one product with the first and second standard stock volumes predetermined by the product information. For example, when the product stock is less than or equal to the first standard stock, i.e. in the range of about 50 to 60% of the appropriate product stock, the integrated management server 100 may provide the notification service for the product stock in the first aid kit vending machine 200 to the manager terminal 300 and the product supplier system 400 matching with the product information by e-mail, text message, pop-up screen, etc. For example, when the product stock is less than the second standard stock, i.e. in the range of about 30 to 40% of the appropriate product stock, the integrated management server 100 may request an order for the corresponding product to the product supplier system 400 by e-mail, etc. Here, the integrated management server 100 may request an order for the product by including the product name, product volume, delivery address, manager name, contact information and the like, and provide the notification service that notifies the product order to the manager terminal 300 by e-mail, text message, pop-up screen, etc. When the product is supplied and warehoused in the first aid kit vending machine 200 in which the product is sold out, the integrated management server 100 may be informed of the supply and warehousing of the product from the manager terminal 300 and the product supplier system 400.

The integrated management server 100 may identify the expiration date of the product from the product information or arbitrarily determine the product sale or the sales suspension as needed, and transmit the same to the first aid kit vending machine 200 or the manager terminal 300.

The integrated management server 100 may receive payment information from a credit card, a check card or the like for example, based on the product sale by the first aid kit vending machine 200, and inter-work with an external payment system (not shown) to request and approve the payment. Accordingly, the integrated management server 100 may check sale details or statistically process the sales information and provide the same to the manager terminal 300. In addition, when receiving a refund request for a product already paid for from the manager terminal 300, the integrated management server 100 may cancel and refund the payment by linking the request with the payment system, and transmit refund information on the refund details to the manager terminal 300.

Therefore, the integrated management system 2 for first aid kit vending machines of the present disclosure described above may integrally manage the first aid kit vending machines 200 in real time by using the plurality of first aid kit vending machines 200 and the integrated management server 100 which inter-work with the manager terminal 300, the product supplier system 400 and the buyer terminal 500 to monitor various information on the first aid kit vending machine and the product being sold.

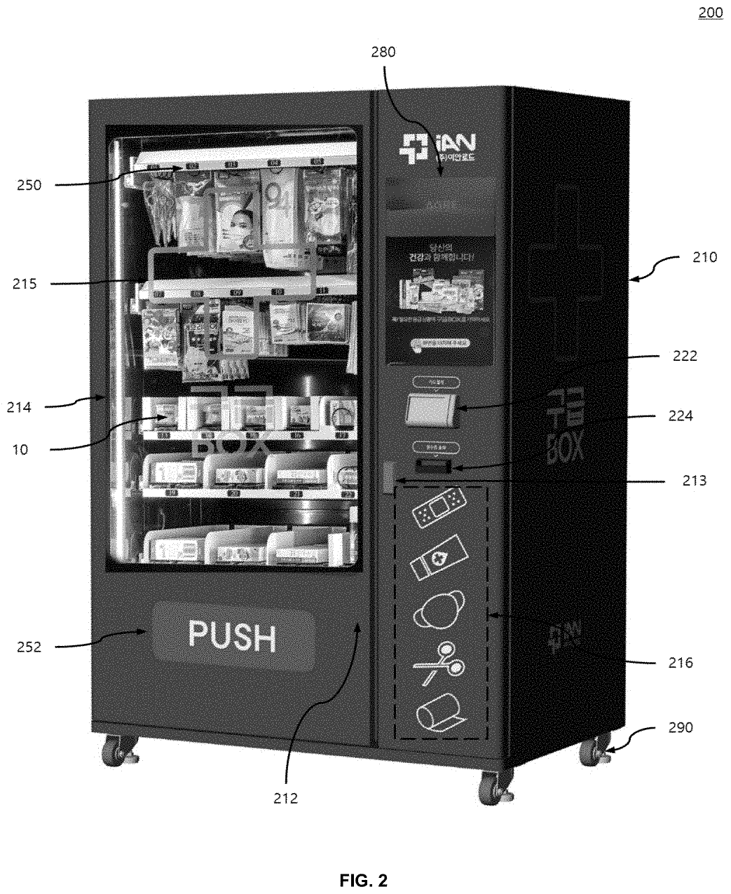

Next, the description focuses on the configuration and function of each of the first aid kit vending machines and integrated management server according to an embodiment of the present disclosure with reference to FIGS. 2 to 5.

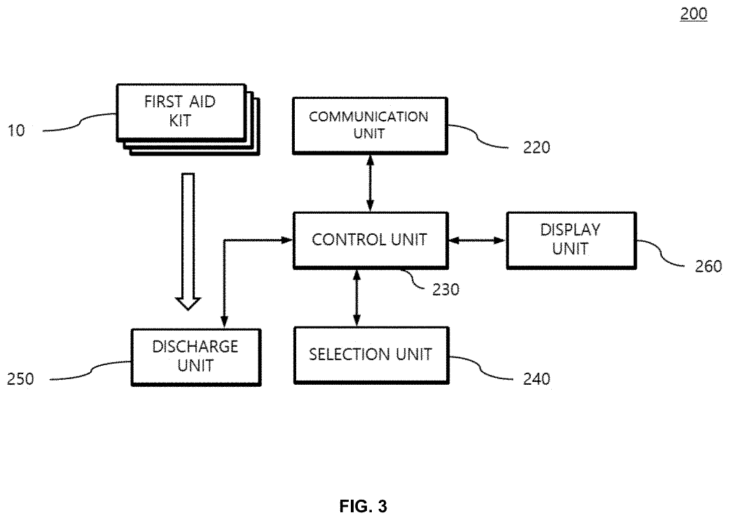

FIG. 2 is a view showing a configuration of the first aid kit vending machine of FIG. 1, and FIG. 3 is a block diagram showing a partial configuration of the first aid kit vending machine shown in FIG. 2.

Referring to FIGS. 2 and 3, the first aid kit vending machine 200 of the present disclosure may accommodate the product having various purposes, i.e. first aid kits 10, in its inner space. Here, the plurality of first aid kits 10 having different purposes may be accommodated therein to cope with various emergencies. Each first-aid kit 10 may include a first-aid medicine, an emergency kit and the like having a purpose to cope with different emergencies. In addition, the first aid kit 10 may be a product set and an individual product for each use.

The first aid kit vending machine 200 may have a configuration of the typical vending machine, and technology related to this configuration is already disclosed in various ways. Therefore, a detailed description thereof is omitted here.

In detail, the first aid kit vending machine 200 of the present disclosure may include a main body 210, a communication unit 220, a control unit 230, a selection unit 240, a discharge unit 250 and a display unit 260.

The main body 210 may form a body of the first aid kit vending machine 200, and the plurality of first aid kits 10 may be arranged in a plurality of columns and rows and accommodated in its inner space. The main body 210 may discharge each of the first aid kits 10 accommodated in its inner space to an outlet 252.

In addition, the main body 210 may have a door 212 on one side of its front surface to open and close the inner space, and a window 214 may be formed at a portion of the door 212 for the first aid kit 10 accommodated in the inner space to be visually checked. The outlet 252 discharging the first aid kit 10 may also be positioned at a lower portion of the door 212.

A touch panel 280, a card reader 222 and a receipt printer 224 may also be positioned on the other side of the front surface of the main body 210. A door lock 213 locking or unlocking the door 212 may also be positioned on the other side of the front surface of the main body 210. The door lock 213 may process functions of a handle and a door key of the door 212, including a screw key for example, and the touch panel 280 may process functions of the selection unit 240 and the display unit 260 of FIG. 3. The card reader 222 may refer to an integrated terminal that processes the payment by identifying a credit card, a debit card, a check card and the like for example, and may process the payment of the selected first aid kit 10. The receipt printer 224 may print a receipt processed by the card reader 222.

In addition, a plurality of the wheels 290 may be positioned under the lower portion of the main body 210, the wheels 290 each including a fixing lever to allow the first aid kit vending machine 200 to be easily moved and fixed to its installation place.

The main body 210 may have a shape of the typical vending machine, for example, a rectangular parallelepiped shape. In the main body 210, a position of the touch panel 280 may be predetermined in consideration of a user's eye level, gaze, touch, etc. For example, an image 215 of a cross or the first aid kit may be displayed on the window 214, a side surface and the like of the main body 210 to allow the user to quickly and easily recognize that this vending machine is a vending machine selling the first aid kit 10. In addition, a pictogram 216 of a visual design representing a representative product of the first aid kit 10 may be displayed below the receipt printer 224 to allow the user to quickly and easily recognize that this vending machine is the first aid kit vending machine 200.

The communication unit 220 may be connected to the communication network 4 to communicate with the manager terminal 300 and the integrated management server 100, and may transmit its own identification information to the integrated management server 100. The communication unit 220 may be connected to the integrated management server 100 inter-working with an external payment system (not shown), for example, a card payment system, to process a request, an approval and the like for the payment of the selected at least one first aid kit 10. In addition, the communication unit 220 may also be directly connected to the external payment system (not shown) through the communication network 4 to process the payment of the first aid kit 10. The communication unit 220 may receive the product information, user manual, advertisement information and the like for the first aid kit from the integrated management server 100.

The selection unit 240 may be, for example, an input button, a touch pad, etc. The selection unit 240 may be positioned on one side of the front surface of the main body 210 to allow the user to select any one based on the use of the first aid kit 10, or the selection units 240 may be respectively positioned corresponding to the first aid kits 10 to allow the user to select one first aid kit 10.

The discharge unit 250 may be driven to discharge the first aid kit 10 selected by the selection unit 240 from the inside of the main body 210 to the outside under a control of the control unit 230. The discharge unit 250 may include actuators, for example, a robot arm, a conveyor belt, a hook hole, a spiral, a gear, a motor, a guide rail and the like, installed corresponding to the respective first aid kits 10 to discharge one of the first aid kits 10 arranged in a plurality of rows and columns. The discharge unit 250 may discharge the paid first aid kit 10 from the main body 210 using these actuators. These actuators may be installed in the typical vending machine, and its structure, configuration, action and the like are already disclosed in various ways. Therefore, a detailed description thereof is omitted here. The discharge unit 250 may discharge the first aid kit to the outside through the outlet 252 positioned at a lower front side of the main body 210.

The display unit 260 may display the product information, the user manual and the product advertisement information for the buyer to select the first aid kit 10 suitable for the emergency. The display unit 260 may display, as a text, an image and a video, various contents of: a product image of the first aid kit 10, the user manual of the first aid kit 10, a component guide of the first aid kit 10, a function description of the first aid kit 10, how to select the first aid kit 10, and how to use the first aid kit vending machine 200, for example.

In addition, the control unit 230 may control the communication unit 220, the selection unit 240, the discharge unit 250 and the display unit 260 to process an overall operation of the first aid kit vending machine 200. That is, the control unit 230 may control the display unit 260 to display various guide information on the first aid kit 10 and the first aid kit vending machine 200, control the selection unit 240 and the discharge unit 250 to discharge the selected first aid kit 10 to be provided to the buyer, and control the communication unit 220 to provide the identification information and sales information to the integrated management server 100. In addition, the control unit 230 may determine the operation state of the first aid kit vending machine 200 such as communication failure, power cut off and malfunction, and transmit its operation state to the integrated management server 100 when the abnormality occurs.

The first aid kit vending machine 200 may receive the product information, the user manual, the advertisement information and the like from the integrated management server 100, may sell the product in such a manner that the buyer selects and pays for the desired product using the touch panel 280, and may transmit the sale information or the stock information to the integrated management server 100 in real time when the product is sold.

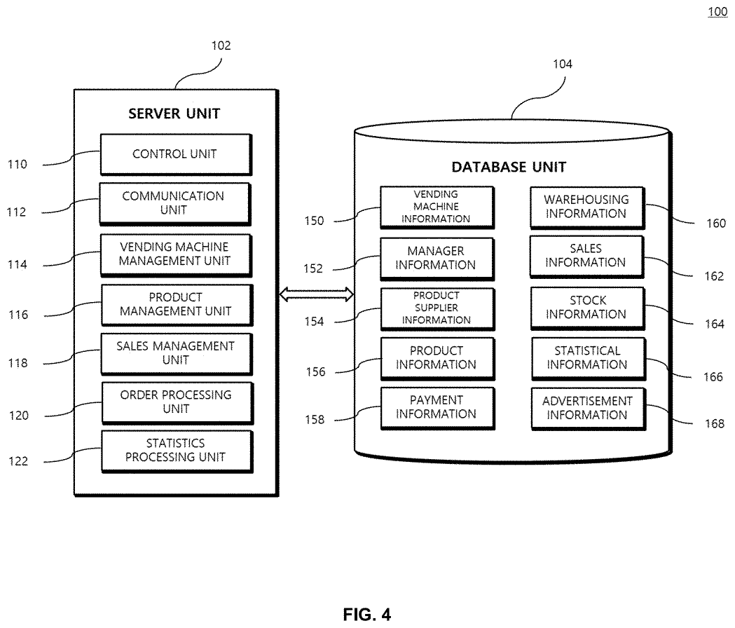

FIG. 4 is a block diagram showing a configuration of the integrated management server shown in FIG. 1.

Referring to FIG. 4, the integrated management server 10 of the present disclosure may integrally manage the plurality of first aid kit vending machines 200 capable of being identified from each other, and installed in different places through communication network 4 in real time, by processing the computerized management, remote management, information inquiry and management, real-time monitoring, payment management, distribution management, product supply management and the like of the first aid kit vending machines 200.

In detail, the integrated management server 100 may include a server unit 102 and a database unit 104. The server unit 102 may include a control unit 110, a communication unit 112, a vending machine management unit 114, a product management unit 116, a sales management unit 118, an order processing unit 120 and a statistics processing unit 122.

The control unit 110 may control an overall operation of the integrated management server 100. That is, the control unit 110 may control the communication unit 112, the vending machine management unit 114, the product management unit 116, the sales management unit 118, the order processing unit 120, the statistics processing unit 122 and the database unit 104 for respective functions to be systemically processed with each other.

The communication unit 112 may include, for example, a wireless communication module, a mobile communication module, etc. The communication unit 112 may be connected to each of the first aid kit vending machine 200, the manager terminal 300, the product supplier system 400 and the buyer terminal 500 through the communication network 4 to enable the data communication therebetween.

The vending machine management unit 114 may register and manage the vending machine information of the plurality of first aid kit vending machines 200 capable of being identified from each other. That is, the vending machine management unit 114 may register the identification information of the first aid kit vending machine 200 and the position information on its installation place, may match the manager of each of the first aid kit vending machines 200 with the identification information, and may store and manage the same. The vending machine management unit 114 may store and manage the information on the product sold by each of the first aid kit vending machines 200 by matching with the identification information. The vending machine management unit 114 may add, modify, delete and edit the identification information of the first aid kit vending machine 200 based on the addition, removal, manager change and the like of the first aid kit vending machine 200. The vending machine management unit 114 may provide the information on the vending machine and the product managed by the manager to the manager terminal 300. The vending machine management unit 114 may provide the vending machine information and product information of the first aid kit vending machines 200 to the manager terminal 300 and the buyer terminal 500 in response to the positions of the manager and the buyer.

The product management unit 116 may register and manage the product information of each of various types of products. The product management unit 116 may register and manage the product information of the product sold in correspondence with each of the first aid kit vending machines 200. The product management unit 116 may match the product information with an order receiver supplying each product, i.e. the product supplier, and may store and manage the same. The product management unit 116 may provide the information on the product sold by each of the first aid kit vending machines 200 to the manager terminal 300 and the buyer terminal 500 in the form of a list, and when one product is selected from the list, the product management unit 116 may provide the product information of the corresponding product. The product management unit 116 may predetermine the information on the standard stock of each of the products for the notification service and the order request. The product management unit 116 may predetermine the expiration date of each product based on the product information.

The sales management unit 118 may calculate the stock information based on the warehousing and sale of the product sold by each of the first aid kit vending machines 200. The sales management unit 118 may receive the sales information of the product sold from each of the first aid kit vending machines 200 in real time and calculate the information on each first aid kit vending machine 200 and the product stock therein. The sales management unit 116 may determine the predetermined expiration date of the product based on the product information and determine the product sale or sales suspension. The sales management unit 118 may process the payment and the like for selling the product from the first aid kit vending machine 200 and may refund the product sold when receiving a request for canceling the payment from the manager terminal 300.

The order processing unit 120 may provide the notification service to the manager terminal 300 in response to the standard stock information, or request an automatic order for the product to the product supplier system 400. For example, the order processing unit 120 may provide the notification service to the manager terminal 300 when the product stock is less than or equal to the first standard stock, and provide the notification service to the manager terminal 300 and simultaneously request an order for the product to the product supplier system 400 when the product stock is less than or equal to the second standard stock. Here, the order processing unit 120 may request an order for the product by transmitting the name, volume, delivery address, manager name, contact information and the like of the product stock less than or equal to the second standard stock to the product supplier system 400 by e-mail. As the product supplier system 400 confirms the supply and arrival of the product and the manager terminal 300 confirms the arrival of the product, the order processing unit 120 may receive the corresponding information from the manager terminal 300 and the product supplier system 400.

The statistics processing unit 122 may statistically process the sales information, based on the product sale of each of the first aid kit vending machines 200, by first aid kit vending machine, by date, by period, by day of the week, by product, etc. The statistics processing unit 122 may classify, extract and provide statistically-processed sales information of the first aid kit vending machines 200 to the manager terminal 300.

In addition, under the control of the control unit 110, the database unit 104 may at least store and manage vending machine information 150, manager information 152, product supplier information 154, product information 156, payment information 158, warehousing information 160, sales information 162, stock information 164, statistical information 166 and advertisement information 168. Under the control of the control unit 110, the database unit 104 may store and manage various information collected and generated in a process of processing all the functions of the integrated management server 100. In addition, the database unit 104 may be included in the integrated management server 100, or may be an independent database server.

In this embodiment, the vending machine information 150 may include the identification information (e.g., vending machine code) of each of the first aid kit vending machines and the position information on the installation place of the vending machine, the manager information on the manager in charge, the product information of the product being sold, etc. The manager information 152 may include personal information such as the manager's name, contact information, identification (ID), e-mail and the like, and the identification information of the vending machine managed by the manager. The product supplier information 154 may include personal information such as the name of the product supplier, the name of a person in charge, contact information, e-mail and the like, and the product information of the product supplied to the first aid kit vending machines 200. The product information 156 may include the vending machine code, the serial number of the product in the vending machine, the product code, the product image, the product name, the product stock in the vending machine, the product stock, the standard stock, the expiration date, the product price, the product supplier, the user manual, the registration date, the product sale or not, the product editable or not, etc. The payment information 158 may include a payment date, a payment amount, and refund or not, based on the product sale of each of the first aid kit vending machines 200. The warehousing information 160 may include the name, warehousing volume, warehousing date and the like of each product supplied from the product supplier system 400. The sales information 162 may include the product code, the sale amount, the sales volume, etc. The stock information 164 may include the stock volume and the like of the product in each of the first aid kit vending machines 200. The statistical information 166 may include the sales information extracted and classified by first aid kit vending machine, by date, by period, by day of the week, by product or the like by statistically processing the sales information of each of the first aid kit vending machines 200. In addition, the advertisement information 168 may include the advertisement image, advertisement video and the like for the product.

Therefore, the integrated management server 100 of the present disclosure may integrally manage the first aid kit vending machines 200 online in real time by identifying the first aid kit vending machines 200 from each other, and not only by installing the first aid kit vending machine 200, but also by processing the warehousing, sale, stock, order, statistics and the like of the product.

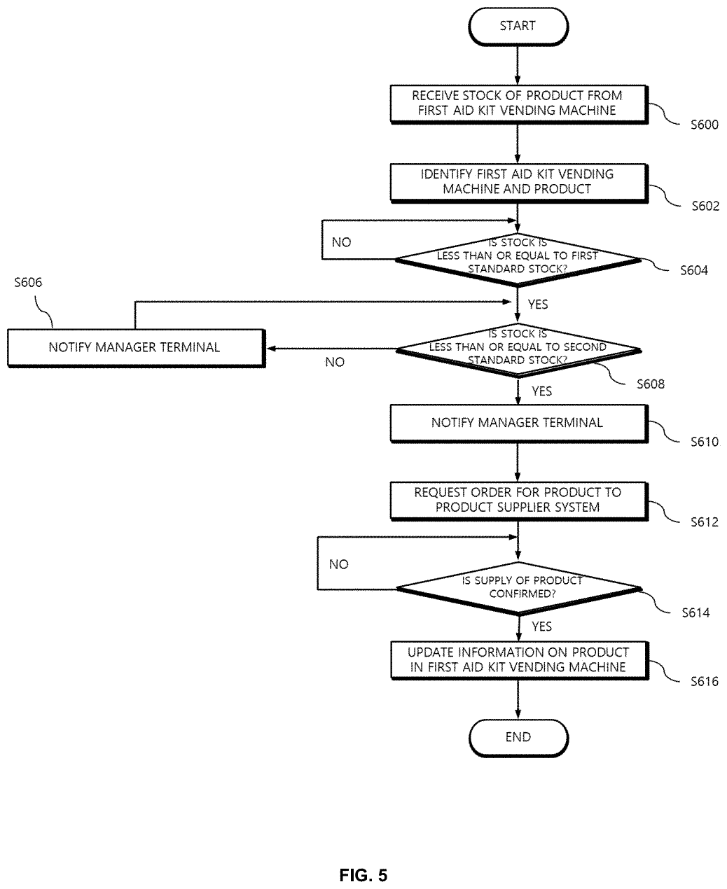

The description subsequently describes a processing procedure according to an embodiment of the integrated management system for first aid kit vending machines of the present disclosure with reference to FIGS. 5 to 15.

FIG. 5 is a flowchart showing a processing procedure of the automatic request for an order based on the product stock in the first aid kit vending machine according to the integrated management system for first aid kit vending machines of the present disclosure.

Referring to FIG. 5, in the integrated management system 2 for first aid kit vending machines of the present disclosure, the integrated management server 100 may receive the stock information of each product from the first aid kit vending machine 200 in an operation S600. In this case, the integrated management server 100 may receive the sales information based on the product sale of the first aid kit vending machine 200 and calculate the stock information, or the first aid kit vending machine 200 may directly calculate the stock information and transmit the stock information to the integrated management server 100. Alternatively, the integrated management server 100 may receive the product stock information of each first aid kit vending machine 200 from the manager terminal 300 of the manager in charge of the first aid kit vending machine 200.

In an operation S602, the integrated management server 100 may identify the first aid kit vending machine 200 to which the product stock information is transmitted and the corresponding product. In an operation S604, the integrated management server 100 may determine whether the product stock is less than or equal to the predetermined first standard stock.

As a result of the determination, when the product stock is less than or equal to the first standard stock, the integrated management server 100 may proceed to an operation S608, and determine whether the product stock is less than or equal to the second standard stock lower than the first stock. However, when the product stock is more than the second standard stock, the integrated management server 100 may proceed to the operation s606 and provide the notification service notifying the stock state of the product to the manager terminal 300.

As a result of the determination, when the product stock is less than or equal to the second standard stock, the integrated management server 100 may provide the notification service notifying the stock state of the product to the manager terminal 300 in an operation S610, and simultaneously request an order for the corresponding product to the product supplier system 400 in an operation S612. That is, when the product stock is less than or equal to the second standard stock or the product is sold out, the integrated management server 100 may request an order for the product by transmitting the name, volume, delivery address, manager contact information and the like of the product to the product supplier supplying the product.

When the supply and arrival of the product are confirmed from the manager terminal 300 and the product supplier system 400 in an operation S614, the integrated management server 100 may proceed to an operation S616 to update the product information based on the warehousing and stock of the product in the first aid kit vending machine 200.

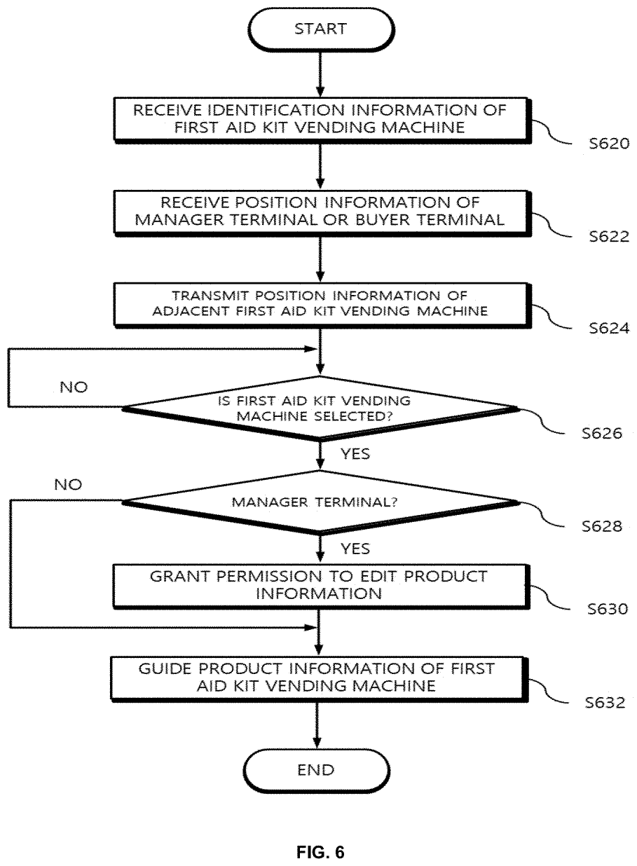

FIG. 6 is a flow chart showing a processing procedure of guiding the position and product of the first aid kit vending machine according to the integrated management system for first aid kit vending machines of the present disclosure.

Referring to FIG. 6, in the integrated management system 2 for first aid kit vending machines of the present disclosure, the integrated management server 100 may receive the identification information of the first aid kit vending machine in an operation S620, and may receive the position information of each manager terminal 300 or that of each buyer terminal 500 in an operation S622.

The integrated management server 100 may extract the information on the position of the first aid kit vending machine 200 close to the position of the manager terminal 300 or buyer terminal 500 in an operation S624, and transmit the extracted position information of the first aid kit vending machine 200 to the manager terminal 300 or the buyer terminal 500. Here, the integrated management server 100 may transmit the extracted position information of the first aid kit vending machine 200 to the manager terminal 300 or the buyer terminal 500 in the form of the electronic map or a list of the installation place by address.

When any one of the first aid kit vending machines 200 is selected on the electronic map or from the list by the manager terminal 300 or the buyer terminal 500 in an operation S626, the integrated management server 100 may determine whether the terminal performing the selection is the manager terminal 300 or the buyer terminal 500 in an operation S628.

As a result of the determination, the integrated management server 100 may proceed to an operation S630 and grant permission to edit the product information in this procedure when the manager terminal 300 performs the selection, and may proceed to an operation S632 when the buyer terminal 500 performs the selection.

The integrated management server 100 may subsequently guide the manager terminal 300 or the buyer terminal 500 to check the product information in the operation S632. Here, when the corresponding terminal is the manager terminal 300, the integrated management server 100 may provide the product information to allow the product information to be checked and edited, and when the corresponding terminal is the buyer terminal 500, the integrated management server 100 may provide the information on the product sold in the selected first aid kit vending machine 200 to allow the product information to be checked.

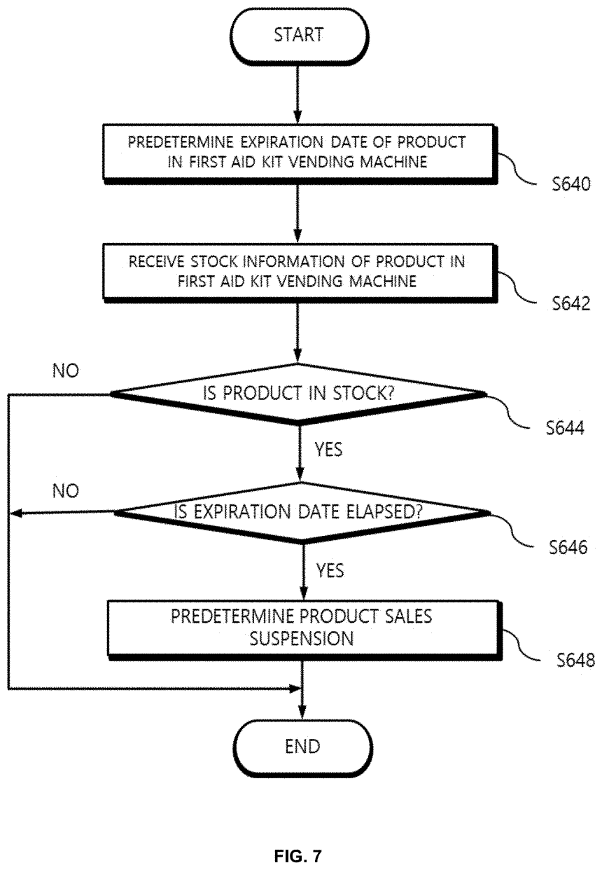

FIG. 7 is a flowchart showing a procedure for determining whether to sell the product based on the expiration date of the product in the first aid kit vending machine according to the integrated management system for first aid kit vending machines of the present disclosure.

Referring to FIG. 7, in the integrated management system 2 for first aid kit vending machines of the present disclosure, the integrated management server 100 may predetermine the expiration date of each product in the first aid kit vending machine 200 in an operation S640.

The integrated management server 100 may receive the stock information of each product in the first aid kit vending machine 200 in an operation S642. The integrated management server 100 may determine whether the product is in stock based on the received stock information of each product in an operation S644. As a result of the determination, when the product is determined to be in stock, the integrated management server 100 may determine whether each product has an elapsed expiration date in an operation S646.

As a result of the determination, when a specific product has an elapsed expiration date, the integrated management server 100 may predetermine the sales suspension and transmit the same to the corresponding first aid kit vending machine 200 in an operation S648. Accordingly, the first aid kit vending machine 200 may stop sale of the product having an elapsed expiration date.

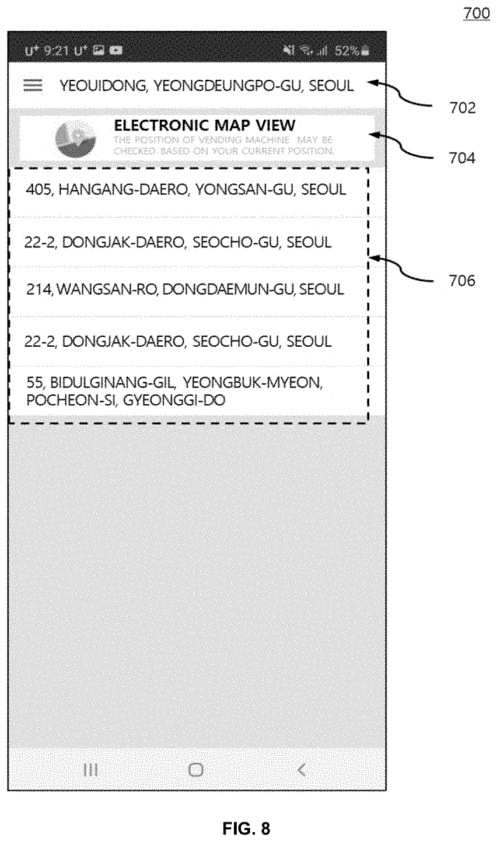

FIGS. 8 to 16 are diagrams each showing an application screen of a manager terminal to manage the first aid kit vending machine according to embodiments of the present disclosure.

That is, FIGS. 8 to 10 each show the first aid kit vending machine application screen of the manager terminal or buyer terminal to check the position and product information of the first aid kit vending machine according to an embodiment of the present disclosure.

Referring to FIGS. 8 to 10, the integrated management system 2 for first aid kit vending machines of the present disclosure may install the first aid kit vending machine application in each of the manager terminal 300 and the buyer terminal 500.

In this embodiment, the first aid kit vending machine application may be installed in each of the manager terminal 300 and the buyer terminal 500, and then transmit its position information to the integrated management server 100. Here, the manager terminal 300 may log in the first aid kit vending machine application and process a user authentication process. The buyer terminal 500 may also log in the first aid kit vending machine application and process the user authentication process.

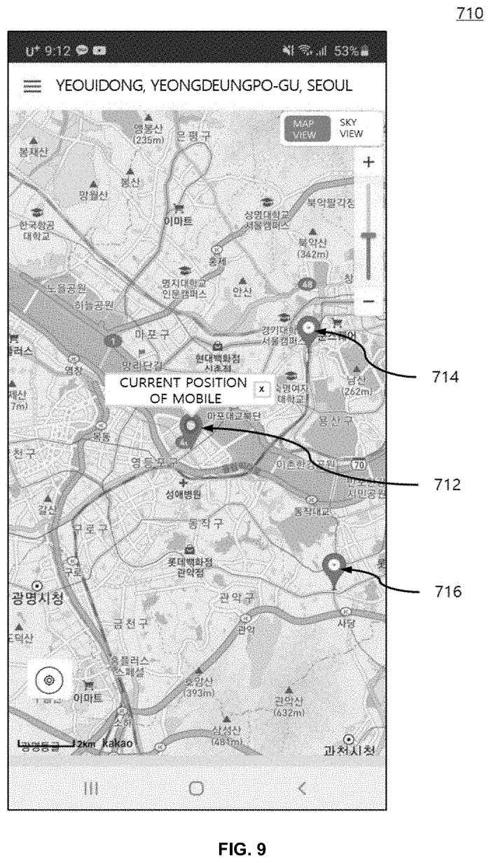

As shown in FIGS. 8 and 9, the integrated management server 100 may display, on an electronic map 710, positions 714 and 716 of the first aid kit vending machines 200 each positioned closest to a current position 702 of the manager terminal 300 or buyer terminal 500. Alternatively, the integrated management server 100 may provide the terminals with a list 706 of the installation places of the plurality of first aid kit vending machine 200 by address to allow the terminals to check the position of at least one first aid kit vending machine 200 using the list 706. In this embodiment, when an electronic map view 704 is selected, the first aid kit vending machine application may provide the electronic map 710 displaying the positions 714 and 716 of the first aid kit vending machines 200 positioned close to a current position 712 of the manager terminal 300 or buyer terminal 500.

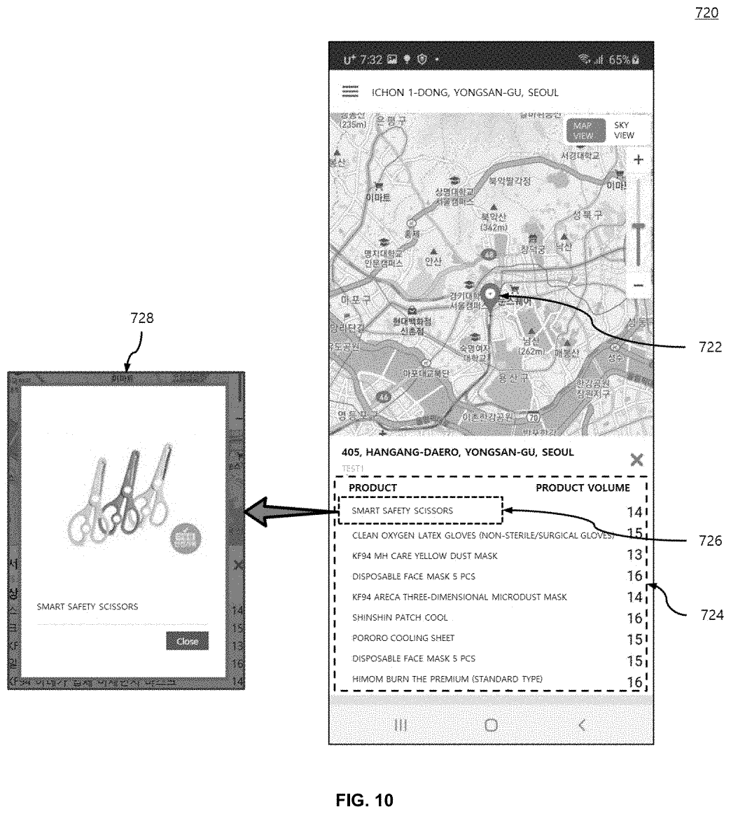

Therefore, each of the manager terminal 300 and the buyer terminal 500 may check the position of each first aid kit vending machine 200 on the electronic map 710 or from the list 706, and may select any one first aid kit vending machine 200. In this embodiment as shown in FIG. 10, when a selection 722 for any one of the first aid kit vending machines 200 is made on an electronic map 72, the first aid kit vending machine application may provide a screen displaying the products sold in the first aid kit vending machine 200 on its one side, and when any one product 726 is selected from a product list 724, the application may display a product image 728 of the selected product 726 in a pop-up window. Here, the product list 724 may display the name and volume of the product to be sold, and when the product image 728 is selected, the application may provide detailed product information (e.g., use, price, user manual and the like of the product). Accordingly, the manager terminal 300 may check and edit the product information, and the buyer terminal 500 may check whether the product is needed.

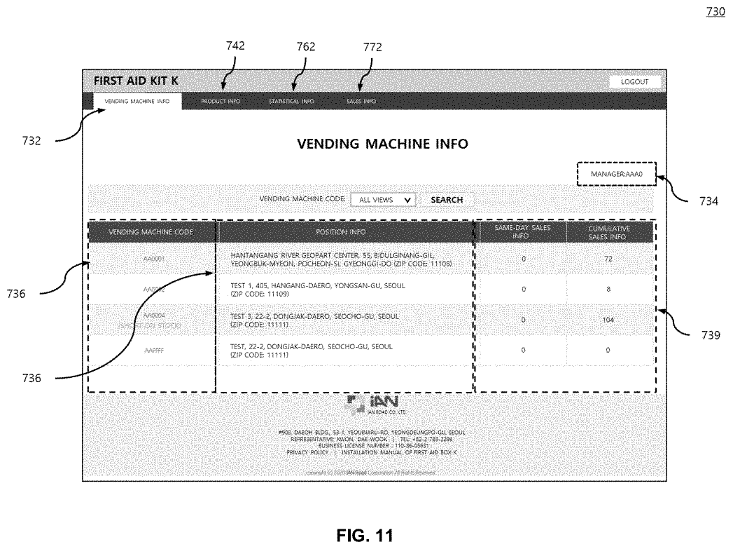

FIGS. 11 to 15 each show the first aid kit vending machine application screen of the manager terminal to manage the first aid kit vending machine and the product information according to an embodiment of the present disclosure.

Referring to FIGS. 11 to 15, when the manager terminal 300 of the present disclosure accesses the integrated management server 100 using the first aid kit vending machine application and logs therein, the application may provide a vending machine information screen 730 displaying the vending machine information, product information, the statistical information and product sales information of the plurality of first aid kit vending machines 200 managed by a manager 734 to allow the manager 734 to check this information.

When the manager terminal 300 selects the vending machine information screen 730 from a vending machine information menu 732, the integrated management server 100 may provide the manager terminal 300 with the screen displaying the vending machine information of each first aid kit vending machine 200 managed by the manager 734 in the form of a list, the vending machine information including a vending machine code 736, position information 738, same-day and cumulative sales information 739, etc. Here, when the manager terminal 300 selects one vending machine code 736, the product information of the first aid kit vending machine 200 may be displayed to allow the product to be checked, and when the manager terminal 300 selects one position information 738, the position of the first aid kit vending machine 200 may be displayed on the electronic map.

In addition, when the manager terminal 300 selects a product information menu 742 on the vending machine information screen 730, the integrated management server 100 may provide a product information screen 740 displaying the information on the product sold in each first aid kit vending machine 200 to allow the product information to be checked.

When a selection or search 744 for the vending machine code of one first aid kit vending machine 200 is made on the product information screen 740, product information 746 of the product sold in each first aid kit vending machine 200 may be displayed in the form of a list. Here, the product information 746 may display the product name, the product image, the product stock in the vending machine, the product stock stored by the manager, the expiration date, the price, etc. When one product name or image 748 is selected from the product information 746, a product information check and correction screen 750 may be displayed to allow the detailed information on the product to be checked and edited.

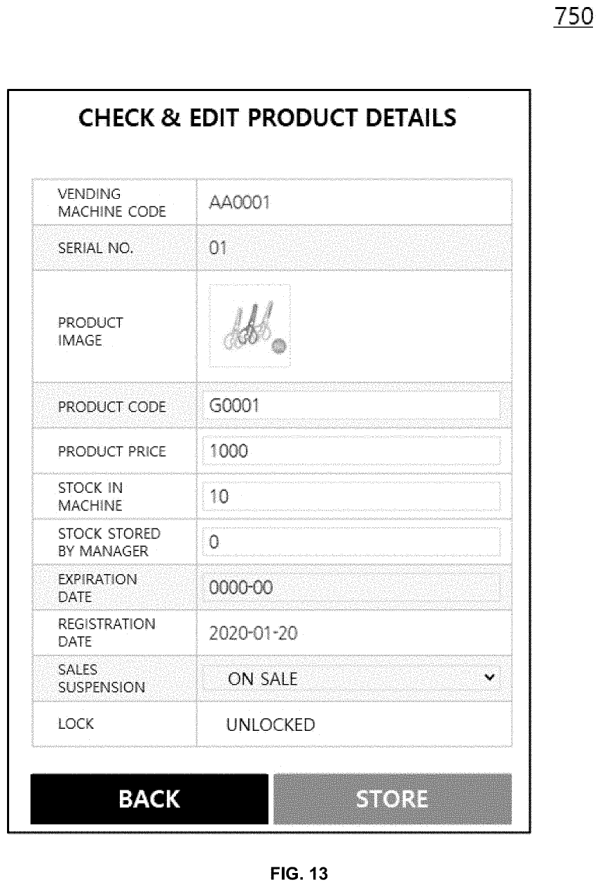

As shown in FIG. 13, the product information check and correction screen 750 may be displayed in the form of a pop-up window, and provided to allow the user to check and modify the following product information: the vending machine code, the serial number of the product in the vending machine, the product name, the product image, the product code, the product price, the product stock in the vending machine, the product stock stored by the manager, the expiration date, the registration date, sales suspension or not, product editable or not (locked or not), etc. Therefore, when the product information is modified and saved by the manager terminal 300, the product information of the first aid kit vending machine 200 may be transmitted to the integrated management server 100.

When the manager terminal 300 requests an order 749 for the product that is sold out using the product information 746 on the product information screen 740, the order request for the product may be transmitted to the integrated management server 100.

In addition, when the manager terminal 300 selects a statistical information menu 762 on the vending machine information screen 730 or the product information screen 740, the integrated management server 100 may statistically process the product sales information of the first aid kit vending machines 200 by vending machine, by date, by period, by product, by day of the week or the like, classify and extract the statistically processed sales information into a desired item set by the manager terminal 300, and provide a statistical information screen 760 allowing the manager to check sale statistics by item. When the manager selects the vending machine code of the first aid kit vending machine 200, or selects the sale date and period such as month, week, year, or the like, the statistical information screen 760 may display statistical information on the sale of each item in the form of a graph, an image, etc.

In addition, when the manager terminal 300 selects a sales information menu 772 on any one of the vending machine information screen 730, the product information screen 740 and the statistical information screen 760, the integrated management server 100 may provide the sales information screen 770 to check the product sales information of the first aid kit vending machine 200 managed by the manager based on a classification 774 by vending machine, a classification 776 by sale date, etc.

The sales information screen 770 may display the code of the vending machine where the product is sold, the product name, the product code, the serial number of the product in the vending machine, the sales volume, the sale date, the cancellation request and the like, and the manager may thus check the sales information by first aid kit vending machine and by sale date. Here, when the manager terminal 300 selects a cancellation request menu 778, the integrated management server 100 may request cancellation of the sale of the corresponding product. Accordingly, when the product sold by the first aid kit vending machine 200 managed by the manager is canceled, the integrated management server 100 may request to cancel the payment approval to the payment system, process the refund, and transmit the refund information on the product refund to the manager terminal 300.

FIG. 16 is a diagram showing an application screen according to another embodiment of the present disclosure.

Referring to FIG. 16, an application screen 800 of this embodiment may be a variation example of the first aid kit vending machine application screens of FIGS. 8 and 9, and may display an electronic map screen 804 and an address list screen 806 on one screen. Here, the electronic map screen 804 and the address list screen 806 may each sort positions 812 of the first aid kit vending machines 200 positioned close to current positions 802 and 810 of the manager terminal 300 or buyer terminal 500 in order and display the same.

Therefore, each of the manager terminal 300 and the buyer terminal 500 may check the position of each first aid kit vending machine 200 on the electronic map screen 804 or the address list screen 806, and may select any one first aid kit vending machine 200. Accordingly, as in FIGS. 8 and 9, the manager terminal 300 or the buyer terminal 500 may select and check the product sold in the first aid kit vending machine 200, the product list including the product, the product image of the selected product and the like on the screens shown in FIGS. 10 to 15, and the manager terminal 300 may manage the first aid kit vending machine 200 and the product.

The manager or the buyer may be provided with the position information of the plurality of first aid kit vending machines 200 from any one of the electronic map and/or the address list shown in FIG. 8, 9 or 16, and select the first aid kit vending machine 200 positioned closest to him/her.

As set forth above, the integrated management system for first aid kit vending machines of the present disclosure may monitor the stock state of the plurality of first aid kit vending machines online in real time, thereby notifying the manager of the stock state or automatically requesting an order for the product to the product supplier to quickly supply the product when the product stock in the first aid kit vending machine is less than or equal to the predetermined standard stock or the product is sold out, and allowing the buyer to purchase the first aid kit necessary for an emergency when needed without the product being sold out.

In addition, the integrated management system for first aid kit vending machines of the present disclosure may integrally manage the plurality of first aid kit vending machines capable of being identified from each other and installed in different places in real time, by performing the computerized management, payment management, distribution management and product supply management of the first aid kit vending machines to sell the product and generate a profit 24 hours a day, 7 days a week on the basis thereof.

In addition, the integrated management system for first aid kit vending machines of the present disclosure may provide the manager with the position information of the first aid kit vending machine and the information on the product being sold, thereby enabling the manager to easily manage the first aid kit vending machine managed by the manager himself/herself. Therefore, it is possible to start a business with a small investment, to have an increased earnings rate by the sale of such a daily life product, and to sell the product at a lower price than in a pharmacy and a convenience store due to the low maintenance cost. These advantages may lead to increased sales, which may result in improved profitability.

In addition, the integrated management system for first aid kit vending machines of the present disclosure may provide the buyer with the position information of the first aid kit vending machine and the information on the product being sold, thereby enabling the buyer to conveniently purchase the product.

In addition, the integrated management system for first aid kit vending machines of the present disclosure may enable the online monitoring of the plurality of first aid kit vending machines in real time. Therefore, the integrated management system for first aid kit vending machines of the present disclosure may guarantee an exclusive right by building this differentiated system, make such an over-the-counter drug vending machine popular because this type of vending machine is suitable for the non-contact era caused by COVID-19, and may be built as a blue-ocean system in the specialized over-the-counter drug market having no competitors.

In the above, the detailed description and drawings show the configuration and operation of the integrated management system for first aid kit vending machines according to the embodiments of the present disclosure. These embodiments are provided only to illustrate the present disclosure, and various changes and modifications could be made without departing from the scope and spirit of the present disclosure.

1. An integrated management system for first aid kit vending machines, comprising:
a plurality of first aid kit vending machines capable of being identified from each other, being installed in different places, and each automatically selling first aid kit having various purposes;
a manager terminal provided with a manager in charge of the first aid kit vending machine; and
an integrated management server connected to the first aid kit vending machine through a communication network and receiving identification information from the first aid kit vending machine to identify the first aid kit vending machine, thereby determining position information on its installation place,
extracting the first aid kit vending machine corresponding to position information of the manager terminal and providing the position information of the extracted first aid kit vending machine to the manager terminal, and
notifying the manager terminal when a product stock in the first aid kit vending machine is less than or equal to a predetermined standard stock or the product is sold out, and requesting an order for the product to the product supplier system when the product stock is less than or equal to the predetermined standard stock or the product is sold out.

2. The integrated management system for first aid kit vending machines of claim 1, wherein the integrated management server displays the position information of the first aid kit vending machine as an electronic map or a list including an address of its installation place to provide the position information of the first aid kit vending machine and product information of the product sold by the first aid kit vending machine to the manager terminal and a buyer terminal of a buyer who wants to purchase the product from the first aid kit vending machine.

3. The integrated management system for first aid kit vending machines of claim 1, wherein the integrated management server further monitors an operation state of the first aid kit vending machine, including at least communication failure, power cut off and malfunction, and informs the manager terminal of the operation state.

4. The integrated management system for first aid kit vending machines of claim 1, wherein the integrated management server predetermines an expiration date of each product in the first aid kit vending machine, and controls the first aid kit vending machine to stop a sale of a specific product when the product has an elapsed expiration date.

5. The integrated management system for first aid kit vending machines of claim 1, wherein the integrated management server provides a notification service to the manager terminal when the product stock in the first aid kit vending machine is less than or equal to a first standard stock; and
provides a notification service to the manager terminal and simultaneously requests an automatic order for the product to the product supplier system when the product stock in the first aid kit vending machine is less than or equal to a second standard stock lower than the first standard stock.
